(19) United States
(12) Patent Application Publication
(10) Pub. No.: US 2013/0246157 A1
(43) Pub. Date: Sep. 19, 2013

(54) INSTANT ELECTRONIC BOOK CLUB

(71) Applicants: Diego Puppin, Arlingon, MA (US); Jeffrey Peng, Needham, MA (US); Mehul Agarwal, Cambridge, MA (US)

(72) Inventors: Diego Puppin, Arlingon, MA (US); Jeffrey Peng, Needham, MA (US); Mehul Agarwal, Cambridge, MA (US)

(73) Assignee: GOOGLE INC., Mountain View, CA (US)

(21) Appl. No.: 13/421,473

(22) Filed: Mar. 15, 2012

(51) Int. Cl. G06Q 30/02; G06Q 30/06

(52) U.S. Cl. 705/14.36; 705/26.1

(57) ABSTRACT

An electronic book club system prompts a user ordering a book to join a club that corresponds to various characteristics of the user, such as the user's reading pace, geography and other interests. A social networking facility manages various aspects of the operation of the book club. Roles for book club members are selected to enhance user interest in the book club. Financial incentives are also provided to incentivize users to become book club members.

### BACKGROUND

1. Technical Field

The subject matter described herein generally relates to the field of electronic books and, more particularly, to systems and methods for automatically creating electronic book clubs.

2. Background Information

Electronic book readers, implemented on special-purpose devices as well as on conventional desktop, laptop and hand-held computers, have become commonplace. Usage of such readers has accelerated dramatically in recent years. Electronic book readers provide the convenience of having numerous books available on a single device, and also allow different devices to be used for reading in different situations. For instance, a reader can buy and start reading a book on a home computer and continue reading on a smart phone device every day while commuting to work. In addition to these advantages, electronic books allow certain efficiencies in social aspects relating to books. For instance, a user may easily submit reviews of books using the reader, and may examine reviews from other readers before purchasing a book.

It would be advantageous to extend the benefits of electronic books yet further, for instance to allow users who begin reading a book at about the same time to form a book club that takes advantage of the features made available by electronic book readers.

### SUMMARY

An electronic book club hosting system includes: a system database storing book data and user profile information; an ordering subsystem configured to provide a portion of the book data responsive to user selection of a book; and a social network subsystem configured to enable user access to a book club based on user profile information and user selection of the book.

In some aspects, the ordering subsystem automatically prompts the user to join the book club.

The social network subsystem may select the book club based on user behavior, user geography, user date of order, user reading pace, user age, user affinities, previous purchases, desired book club size and user interest factors.

In some aspects roles are selected and are changed from time to time. In one specific aspect a student is selected to fill a role in the book club; in another a teacher is selected to fill a role.

In certain aspects the ordering subsystem provides a financial incentive for the user to join the book club.

In still another aspect, the social network subsystem allows the user to join the book club as an anonymous follower.

In some aspects, computer-implemented methods provide corresponding functionality, for instance receiving a user order for a book, fulfilling the user order, prompting the user to join the book club, receiving a reply from the user and directing a social network processing facility to connect the user with the book club based on the user's reply. In related aspects, the book club is selected responsive to parameters relating to user behavior, user geography, user date of order, user reading pace, user age, user affinities, previous purchases, desired book club size, and user interest.

In other aspects, methods provide for exchange of annotations or references among book club members and for scheduling of activities by the book club. In yet other aspects, the user selects the book club from a plurality of potential book clubs. In still another aspect, the user is notified when a book club is formed.

In yet another aspect a method includes receiving a user order for a book, prompting the user to join the book club, and directing portions of the book to be provided to the user responsive to a set of parameters for the book club. In a related aspect, the portions are delivered at a frequency that corresponds to a desired reading pace of the book club.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

FIG. 1 is a high-level diagram illustrating a networked environment that includes an electronic book reader.

FIG. 2 illustrates a logical view of a reader module used as part of an electronic book reader.

FIG. 3 illustrates a logical view of a system database that stores data related to the book club hosting system.

FIG. 4 illustrates one embodiment of components of an example machine able to read instructions from a machine-readable medium and execute them in a processor.

FIG. 5 illustrates one exemplary method of implementing an electronic book club.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Electronic Book System Overview

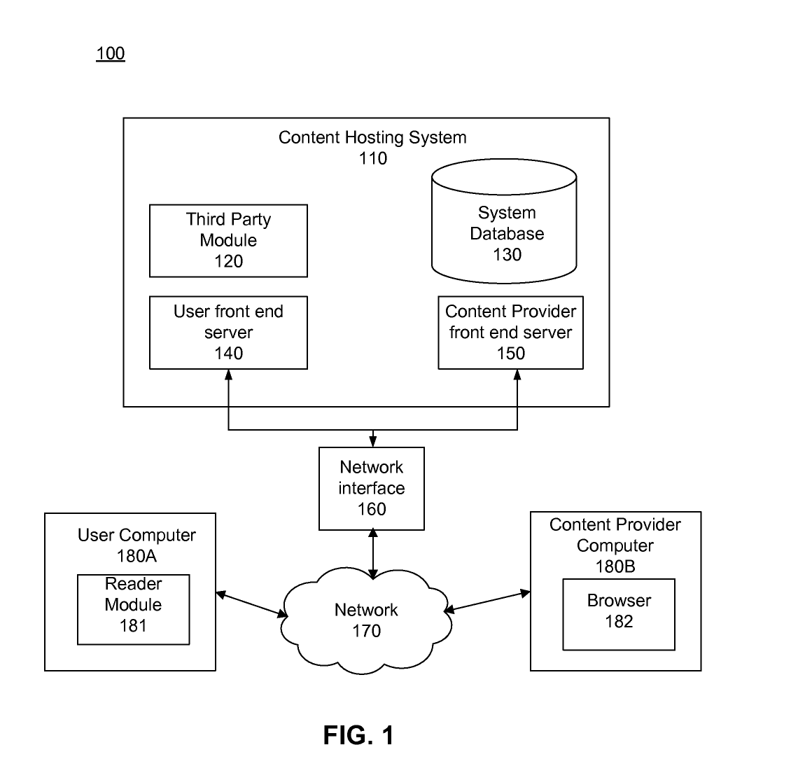

FIG. 1 is a high-level diagram illustrating a networked environment 100 that includes a content hosting system 110 that, as described herein, also serves as a book club hosting system. The content hosting system 110 makes available for purchase, licensing, rental or subscription books that can be viewed on user and content provider computers 180 (depicted in FIG. 1, for exemplary purposes only, as individual computers 180A and 180B) using a reader module 181 or browser 182. The content hosting system 110 and computers 180 are connected by a network 170 such as a local area network or the Internet.

The network 170 is typically the Internet, but can be any network, including but not limited to any combination of a LAN, a MAN, a WAN, a mobile, a wired or wireless network, a private network, or a virtual private network. The content hosting system 110 is connected to the network 170 through a network interface 160.

As discussed above, only a single user computer 180A is shown, but in practice there are many (e.g., millions of) user computers 180A that can communicate with and use the content hosting system 110. Similarly, only a single content provider computer 180B is shown, but in practice there are many (e.g., thousands or even millions of) content providers 180B that can provide books and related materials for content hosting system 110. In some embodiments, reader module 181 and browser 182 include a content player (e.g., FLASH™ from Adobe Systems, Inc.), or any other player adapted for the content file formats used by the content hosting system 110.

User computer 180A with reader module 181 is used by users to purchase or otherwise obtain, and access, materials provided by the content hosting system 110. Content provider computer 180B is used by content providers (e.g., individual authors, publishing houses) to create and provide material for the content hosting system 110. A given computer can be both a client computer 180A and content provider computer 180B, depending on its usage. The hosting service 110 may differentiate between content providers and users in this instance based on which front end server is used to connect to the content hosting system 110, user logon information, or other factors.

The content hosting system 110 comprises a user front end server 140 and a content provider front end server 150, each of which can be implemented as one or more server class computers. The content provider front end server 150 is connected through the network 170 to content provider computer 180B. The content provider front end server 150 provides an interface for content providers—whether traditional book publishers or individual self-publishing authors—to create and manage materials they would like to make available to users. The user front end server 140 is connected through the network 170 to client computer 180A. The user front end server 140 provides an interface for users to access material created by content providers.

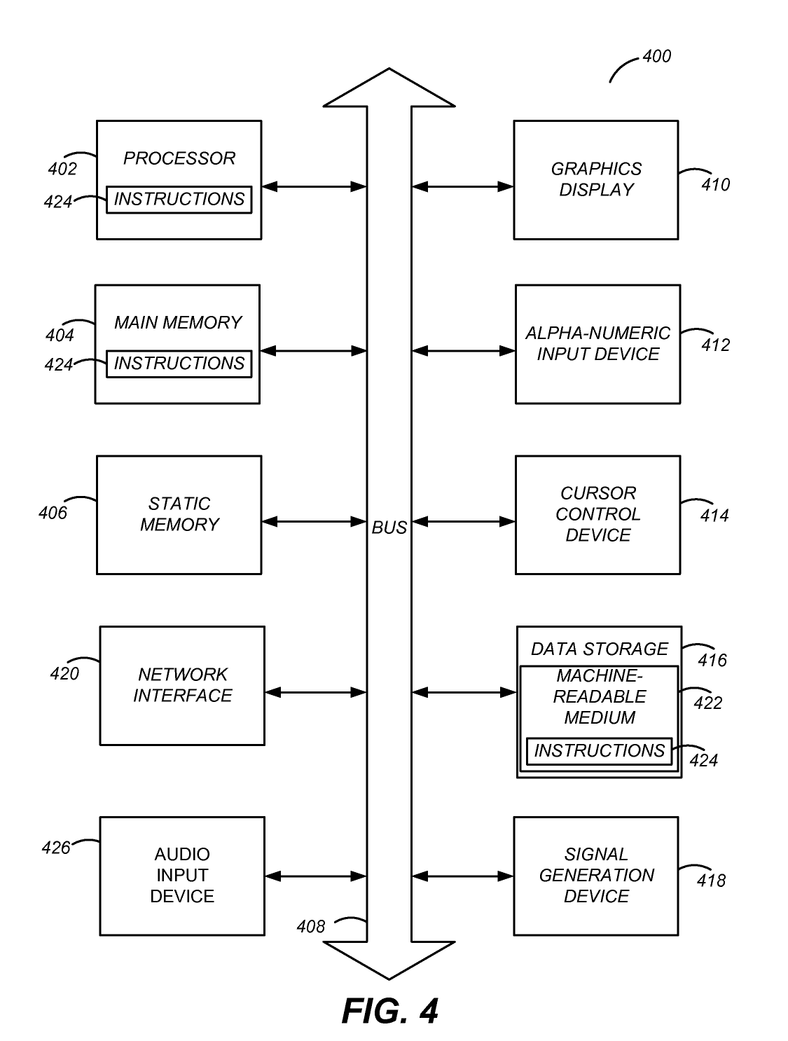

The content hosting system 110 is implemented by a network of server class computers that can include one or more high-performance CPUs and 1G or more of main memory, as well as 500 GB to 2 Tb of storage. An operating system such as LINUX is typically used. The operations of the content hosting system 110, user front end server 140 and content provider front end server 150 as described herein can be controlled through either hardware (e.g., dedicated computing devices or daughter-boards in general purpose computers), or through computer programs installed in computer storage on the servers of the system 110 and executed by the processors of such servers to perform the functions described herein. More detail regarding implementation of such machines is provided in connection with FIG. 4. One of skill in the art of system engineering and, for example, media content hosting will readily determine from the functional and algorithmic descriptions herein the construction and operation of such computer programs and hardware systems.

The content hosting system 110 further comprises a system database 130 that is communicatively coupled to the network 170. The system database 130 stores data related to the content hosting system 110 along with user and system usage information and, in some embodiments, provides related processing.

The system database 130 can be implemented as any device or combination of devices capable of persistently storing data in computer readable storage media, such as a hard disk drive, RAM, a writable compact disk (CD) or DVD, a solid-state memory device, or other optical/magnetic storage mediums. Other types of computer-readable storage mediums can be used, and it is expected that as new storage mediums are developed in the future, they can be configured in accordance with the descriptions set forth above.

The content hosting system 110 is further comprised of a third party module 120. The third party module 120 is implemented as part of the content hosting system 110 in conjunction with the components listed above. The third party module 120 provides a mechanism by which the system provides an open platform for additional uses relating to electronic books, much as an application programming interface allows third parties access to certain features of a software program. In some embodiments, third party input may be limited to provision of content via content provider computers 180B and content provider front end server 150. Given the wide range of possible operation of system 100, however, in some embodiments it may be desirable to open additional capabilities for third parties who are not providing content to access the system. For example, anonymous use data from groups of readers may be made available via third party module 120 to allow development of reading statistics for particular books. As a specific example, aggregated data regarding average user speed of reading through a particular book may be used to determine how quickly a book club might suggest a reader progress through a book. In a typical embodiment, the user is provided with various options regarding the information collected and processed as described herein, and the user can opt not to have certain information about the user collected or used, if the user would rather not provide such information. The book club functions described herein are in some embodiments implemented directly via content hosting system 110 and in other embodiments implemented via third party module 120.

In this description, the term “module” refers to computational logic for providing the specified functionality. A module can be implemented in hardware, firmware, and/or software. Where the modules described herein are implemented as software, the module can be implemented as a standalone program, but can also be implemented through other means, for example as part of a larger program, as a plurality of separate programs, or as one or more statically or dynamically linked libraries. It will be understood that the named modules described herein represent one embodiment of the present invention, and other embodiments may include other modules. In addition, other embodiments may lack modules described herein and/or distribute the described functionality among the modules in a different manner. Additionally, the functionalities attributed to more than one module can be incorporated into a single module. In an embodiment where the modules as implemented by software, they are stored on a computer readable persistent storage device (e.g., hard disk), loaded into the memory, and executed by one or more processors included as part of the content hosting system 110. Alternatively, hardware or software modules may be stored elsewhere within the content hosting system 110. The content hosting system 110 includes hardware elements necessary for the operations described here, including one or more processors, high speed memory, hard disk storage and backup, network interfaces and protocols, input devices for data entry, and output devices for display, printing, or other presentations of data. FIG. 4 provides further details regarding such components.

Numerous variations from the system architecture of the illustrated content hosting system 110 are possible. The components of the system 110 and their respective functionalities can be combined or redistributed. For example, the system database 130, third party module 120, user front end server 140, and content provider front end server 150 can be distributed among any number of storage devices. The following sections describe in greater detail the reader module 181, system database 130, and the other components illustrated in FIG. 1 in greater detail, and explain their operation in the context of the content hosting system 110.

### Reader Module

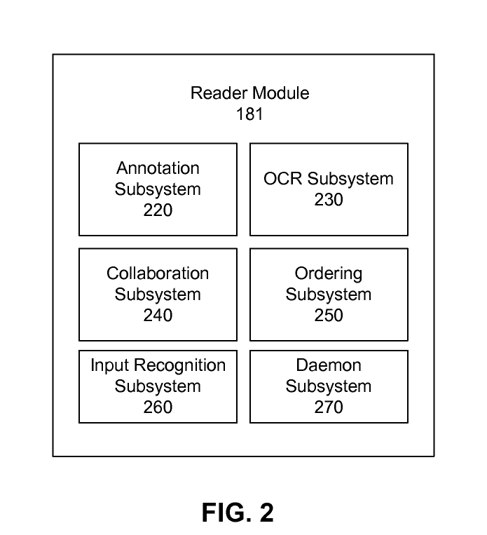

FIG. 2 illustrates a functional view of a reader module 181 used as part of a electronic book system. In the embodiment described above in connection with FIG. 1, the reader module is implemented on user computer 180A, but it should be recognized that in other embodiments, portions discussed herein could also be implemented on other computers (e.g., those in content hosting system 110) that are in communication with reader module 181.

Reader module 181 is configured, in the aspects discussed herein, to address the book club features detailed below. As described below, some of these book club features are interactive and may involve use of annotations, cross-referencing between works (e.g., a book and a sequel book), reference to glossary or definitions sections, and the like. The book club features discussed below are social and collaborative as well. Book club activity involves not only attention to the specific book, but creation of discussion notes and reference to other related sources in preparation for book club discussions.

Reader module 181 includes various subsystems to facilitate these specialized uses. In the embodiment illustrated in FIG. 2, reader module 181 includes an annotation subsystem 220, an OCR subsystem 230, a collaboration subsystem 240, an ordering subsystem 250, an input recognition subsystem 260, and a daemon subsystem 270. Many of these subsystems interact with one another, as described below.

Annotation subsystem 220 provides various user tools and interfaces to allow readers to mark up portions of an electronic book as they may find most helpful for upcoming book club sessions annotation subsystem 220 includes conventional features such as highlighting and text entry tools, and also includes more advanced tools. For example, as described below annotation subsystem 220 keeps track of book portions for which a reader has provided annotations, and collects those portions into a personalized guide based on a user command. Such annotations are in some embodiments available not only for the user's personal use, but are shared among other book club members.

OCR subsystem 230 is a recognition subsystem that takes information originally in one form and converts it into a second form by recognizing patterns and/or known symbols. For example, OCR subsystem 230 communicates with annotation subsystem 220 to convert handwritten reader notes (entered graphically via finger or stylus gestures on a touch screen, for instance) into machine readable text. As used here, the term “OCR subsystem” includes not only optical character recognition, but other types of recognition as well, for instance: voice-to-text recognition to allow a reader to speak rather than write annotations; image to text recognition for photographs the user may take of related material; and other types of recognition as well that may be provided within an electronic book or as a third party add-on. As a specific example, one type of recognition that may be helpful in a book about popular music is recognition of a sound (e.g., a melody) and translation into a visual score (e.g., sheet music) for that melody.

Collaboration subsystem 240 provides various user functions that allow readers to work together. As detailed below, for example, users can share their annotations and notes with their book club, other book clubs, or other readers worldwide of their electronic book. Further, collaboration subsystem 240 includes social network facilities to permit readers to communicate with one another with audio and visual chat, to ask and answer questions, and to submit questions to a moderator of the club as described below.

Ordering subsystem 250 represents tools that allow readers to obtain electronic books and related materials. In one embodiment, ordering subsystem 250 is implemented as an electronic marketplace (e.g., the DROID™ marketplace implemented on the ANDROID™ operating system for smart phones and tablet computers). Third parties offer electronic books and related materials such as character guides, updates, workbooks, and the like. Some of these materials are available for purchase; others are free. In some embodiments, provision via other mechanisms (e.g., subscription, barter, “pay-per-view”) is supported, as may be desired by any subset of a reader community or content provider group.

Input recognition subsystem 260 provides user interface tools to facilitate use of electronic books and related features. For instance, by sensing particular gestures on a touch screen of user computer 180A, the system temporarily shifts display of a book from a current page to a new section, while keeping track of the section of primary interest. Thus, a reader of a historical book on a Civil War battle can quickly switch between the text of a chapter and a map related to the battle that may be presented at another location in the book, or a user reading a section of a book can quickly jump to a glossary section of the book for a definition of an unfamiliar term or concept.

Reader module 181 is configured to permit user-selected applications to run to enhance a reader's ability to work with an electronic book. For instance, a reader may purchase an application that provides a chapter synopsis of the book so that if the reader has not picked up the book for some time, the reader can be reminded of the content that has already been read. In addition, reader module 181 includes a daemon subsystem 270 to provide additional add-on features without the reader launching a visible application for such features. As one example, a reader of a book about music may have one or more daemons that allow recognition of images of sheet music and audio playback of the corresponding music, or that recognize particular melodies that may be captured by a microphone associated with user computer 180A, or that synthesize musical compositions based on a reader's input.

### System Database

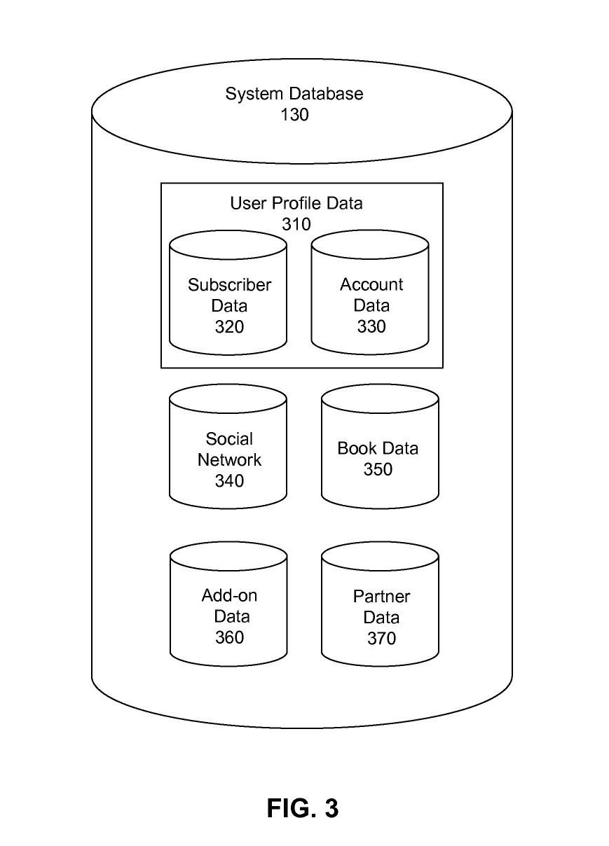

FIG. 3 illustrates a functional view of the system database 130 that stores data related to the content hosting system 110. The system database 130 may be divided based on the different types of data stored within. This data may reside in separate physical devices, or it may be collected within a single physical device. System database 130 in some embodiments also provides processing related to the data stored therein.

With respect to content providers, partner data 370 comprises information regarding content providers, or partners, registered with the content hosting system 110 that have permission to create and deliver content. Partner data 370 includes provider contact information.

For providers creating paid books or other content, partner data 370 contains billing and revenue sharing information for the provider. Some providers may create subscription channels while others may provide single payment or free delivery of electronic books and related information. These providers may have specific agreements with the operator of the content hosting system 110 governing how revenue will flow from the content hosting system 110 to the provider. These specific agreements are contained in the partner data 370.

Alternatively, some providers may not have specific agreements with the operator of the content hosting system 110 governing how revenue will flow from the content hosting service 110 to the provider. For these providers, partner data 370 comprises a standardized set of information dictating how revenue will flow from the content hosting system 110 to the providers. For example, for a given partner, the partner data may indicate that the content hosting system 110 receives 25% of the revenue for an item provided to a user, and the content provider receives 75%. Of course other more complex allocations can be used with variable factors based on features, user base, and the like.

User profile data storage 310 includes information about an individual user, to facilitate the payment and collaborative aspects of system 100. Subscriber data storage 320 includes identifying information about the user. In some embodiments this is information provided by the user manually, while in other environments the user is given an opportunity to agree to the collection of such information automatically, e.g., the electronic books the user has obtained and the book clubs or social network groups the user has joined. In some embodiments, subscriber data storage 320 also maintains information regarding how far the user has progressed in a particular book, to allow, for example, a user to read part of a book on a smart phone while on a bus and continue reading from the same spot on the user's desktop computer when at home. As noted above, subscriber data storage 320 contains, in some embodiments, data about the user that is not explicitly entered by the user, but which is tracked as the user navigates through books and related materials. Subscriber viewing data includes, for example, the total time spent by the user per chapter, average time spent per week in a book, proportion of time spent on initial reading as opposed to reviewing previously read portions, and the like. Such information is in some embodiments used to help the user decide which of several book clubs may be most enjoyable to the user.

Account data storage 330 keeps track of the user's payment mechanisms (e.g., Google Inc.'s CHECKOUT®) related to the user's ability to obtain content from system 100.

Social network 340 maintains in data storage devices the information needed to implement a social network engine to provide the collaborative features discussed herein, e.g., social graphs, social network preferences and rules that together implement instant book clubs. In practice, it may be that various distributed computing facilities implement the social networking facilities and functions described herein. For example, certain existing features of the Google+social networking facility can implement some of the functions of social network facility 340. Social network 340 will be used here to reference any facilities to implement the social networking functions discussed herein.

Book data 350 stores the actual content that is provided to users upon their request, such as electronic book files, as well as related information as may be maintained (e.g., metadata regarding such books).

Add-on data storage 360 maintains information for related features. In some instances, this may include non-static data relating to books (e.g., usage statistics, book ratings and reviews) and in some embodiments book club information (e.g., book club rosters).

In one embodiment, conventional mechanisms are used to implement many of the aspects of system database 130. For example, the existing mechanisms from Google Inc.'s BOOKS™, GMAIL™, BUZZ™, CHAT™, TALK™, ORKUT™, CHECKOUT™, YOUTUBE™, SCHOLAR™, BLOGGER™, GOOGLE+™ and other products include aspects that can help to implement one or more of storage facilities 310, 320, 330, 340, 350, 360 and 370 as well as modules 220, 230, 240, 250, 260 and 270. Google Inc. already provides eBook readers for ANDROID™ devices (phones, tablets, etc.), iOS devices (iPhones®, iPads® and other devices from Apple, Inc.) and various desktop Web browsers, and in one embodiment Google Inc.'s EDITIONS™ and EBOOKSTORE™ eBook-related applications and facilities are modified to provide the functionality described herein.

As mentioned above, user profile data 310 is usable on a per-reader basis and is also capable of being aggregated for various populations of subscribers. The population can be the entire subscriber population, or any selected subset thereof, such as targeted subscribers based on any combination of demographic or behavioral characteristics, or content selections. System-wide usage data includes trends and patterns in usage habits for any desired population. For example, correlations can be made between electronic books and add-ons that purchasers of those books choose (presumably related in some way to those books). In one embodiment, when a user obtains a new book, such data are used to recommend other related items the user might also be interested in obtaining. Valuation of items, relative rankings of items, and other synthesized information can also be obtained from such data.

### Computing Machine Architecture

FIG. 4 is a block diagram illustrating components of an example machine able to read instructions from a machine-readable medium and execute those instructions in a processor. Specifically, FIG. 4 shows a diagrammatic representation of a machine in the example form of a computer system 400 within which instructions 424 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include graphics display unit 410 (e.g., a plasma display panel (PDP), a liquid crystal display (LCD), a projector, or a cathode ray tube (CRT)). The computer system 400 may also include alphanumeric input device 412 (e.g., a keyboard), a cursor control device 414 (e.g., a mouse, a trackball, a joystick, a motion sensor, or other pointing instrument), a data store 416, a signal generation device 418 (e.g., a speaker), an audio input device 426 (e.g., a microphone) and a network interface device 420, which also are configured to communicate via the bus 408.

The data store 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network (not shown) via network interface 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Instant Book Club for Electronic Books

Books, including electronic books, routinely generate sufficient interest among a wide enough audience that book clubs develop around them. Traditionally, such clubs have had members physically meet at a set location, such as a café, book shop or member's home. The club members often set an agenda and tone for the club, such as the portion of a book that is to be discussed and the depth/tone of analysis that is to be included in the club's discussion. With the systems and processes described above, such physical meetings may or may not be required for a meaningful discussion, so book clubs can be physical, virtual or a mix. Likewise, the systems and processes described above permit a great deal of tuning for the approach of any particular club, so that potential members can join a club (or avoid joining a club) based on information that is far more nuanced than simply that the club intends to discuss a particular book.

In one embodiment, users of reader module 181 who regularly purchase electronic books via ordering subsystem 250 are periodically prompted to purchase books that, based on their prior purchases, are predicted to be of interest to them. In one specific embodiment, ordering subsystem 250 provides an offer to a user to obtain access to recommended books via a subscription. One option of such a subscription is on a per-book basis; another is on a per-chapter basis. In an alternate embodiment, ordering subsystem 250 merely prompts the user to purchase an electronic book, either at a full or discounted price. However a user decides to access a book via ordering subsystem 250, ordering subsystem 250 then prompts the user to join an instant book club.

Collaboration subsystem 240 is configured to support creation of such instant book clubs, for instance through existing social networking facilities (e.g., by creating a “circle” for the book club using the Google+social networking facility). Typically, the user is invited to join a specific book club based on various parameters suggesting that the user would find such a club to be of interest. The date that the user purchased access to the book is one such factor, and in some embodiments is a primary factor determining to which club a particular user will be invited. There is generally a preference in book clubs intended for discussion of a book during (rather than after) reading that members be at about the same place in the book for each meeting of the club. Thus, basing member selection on when the user ordered the book is often helpful in suggesting an appropriate club.

However, other factors may be used in various embodiments as well. Some readers have far more time for pleasure reading than others and therefore progress much more quickly through books. Therefore, the user's historical speed in completing reading of a purchased book is a reasonable factor to use in determining an appropriate book club for a reader. This information is available in the user profile data 310 of system database 130, as discussed above. Likewise, other user profile data 310, such as the geographic location of the user, is also a parameter that is used in some embodiments to suggest an instant book club for the user to join. For book clubs that may wish to undertake physical rather than merely virtual meetings, this may be a primary factor in driving members to the club.

Yet more nuanced factors are available via the data in social network 340, and similarly such data are in certain embodiments used to suggest which of several possible book clubs a user may wish to join. Consider, for example, the classic 1974 novel, ZEN AND THE ART OF MOTORCYCLE MAINTENANCE, by Robert Pirsig. A user might wish to join one of two very different types of book clubs for this book—one made up of those primarily interested in philosophy, and the other made up of those primarily interested in motorcycle touring. The data in social network 340 and user profile data 310 are in many instances usable to determine which demographic may be of the greatest interest to a particular user.

The social network facilities discussed above provide, in some embodiments, the means by which users choose whether to join a particular club and which to join. In some embodiments, the social network facilities also actually implement the clubs. In yet further embodiments, the social networking facilities collect user comments and annotations relating to a book and filter, route and process those comments and annotations in a manner that implements customized user experiences without explicitly forming separate clubs. To provide an example, in one specific embodiment, a map user interface allows a user to determine from which geographic locations the user may wish to see other users' comments on a book. In this manner, a reader in Boston may choose to see only the comments of other New Englanders while another reader in Colorado may choose to see the comments of those in the Rocky Mountain region of the country. Some readers may wish to focus on comments of those in other regions of the country, so a reader in California may wish to see the comments of readers located in Texas. Particularly for books with very large audiences, or books that may be expected to generate different comments in different regions, allowing such selection based on geography can be of great value to some readers (for instance, students and other researchers).

As mentioned previously, pace of reading is another factor that may drive readers to want to join one book club or another. Users who progress slowly through a book may not wish to be pushed by being in a club that has a one chapter per day pace, while others may not wish to wait for a club that is on a one chapter per week pace. One manner of dealing with the pacing factor is to provide a user with incremental access to the book based on which book club the user has requested to join. For example, if the user selects a club that is on a one chapter per week pace, the book data 350 in system database 130 is metered in one embodiment so that members of that club cannot read ahead and spoil an upcoming plot twist for other members. In one embodiment, a user prompt (e.g., provided by annotation subsystem 220) shows a reader, for instance by ticks on a progress bar portion of a user interface, how far other readers in the book club have progressed in their reading at any particular time. In this manner, a set pace need not be established for a club, but members may determine on their own whether to speed up or slow their pace to stay with their fellow book club members. Book data 350 includes, in some embodiments, this progress information to permit, for example, a user to seamlessly continue reading a book from the last point viewed on any of the user's devices, including the user's dedicated reader device, personal computer, tablet computer and smartphone. Such progress information is transferred from book data 350 to the data in social network 340 to allow such information to be graphically depicted (typically without user identification) on the progress bar of other club members' reader modules 181.

For book clubs that do not include physical meetings of members, social networking features provide various mechanisms for members to interact. Real-time interaction is provided via social network 340 having chat (text, audio and/or video) and “hangout” features, such as are provided in the Google+Chat facility for interaction among users. Interaction that is not in real-time is also supported by allowing users to share their annotations, comments, reviews, blog entries and other forms of expression with other members of the book club. In one embodiment various user settings permit tuning of such modes of communication on a per-club and per-user basis, similar to settings available on a per-circle basis in the Google+facility.

Publishers may wish to provide incentives for book clubs, as they are widely considered to help drive book sales, and ordering subsystem 250 is configured in certain embodiments to facilitate such incentives. For example, a publisher may allow a reader to progress to the first 10% of a book without charge, and then ordering subsystem 250 presents the user with a choice to join a book club for incremental reading at a first cost or purchase the book outright at a second cost. Should the reader join the book club, ordering subsystem 250 directs book data 350 to push portions of the book to the user at a predetermined pace matching that set for the selected book club. Another model used in certain embodiments is to establish a subscription to a book club (say, $20 per month) in which a user can join one or more clubs and, based on joining the club, be provided with incremental or full access to the book the club is discussing. These various access models permit publishers to achieve differential pricing in a manner that incentivizes book club membership and ongoing interest in each publisher's offerings.

Further incentives to users are provided by allowing users to request to form a new book club, to name/rename book clubs, to select moderators and discussion group leaders for a club (e.g., by the system automatically suggesting chapter moderators on a rotating basis to allow all members to have a turn at leading the group, by allowing the members to elect moderators, and by selecting moderators based on a scoring metric regarding each member's profile or level of participation). In one embodiment, leaders are selected based on their status as students, allowing teachers to provide extra credit for such leadership. In another embodiment, teachers are recommended as leaders, lending credibility to the book club and raising the stature of the selected teachers. Social network profile information is used in some of these embodiments to automatically derive such status information; in other embodiments a user interface prompt elicits such status information from club members and prospective members.

In some embodiments, book club members provide recommendations to other members for other books that may be of interest, for instance by updating user profile information about themselves that then gets reported to the other members of the book club. In one specific embodiment, ordering system 250 adjusts pricing for book club members who order books based on the recommendations of other members, thus providing incentives for members to generate and review such recommendations. Likewise, in one embodiment user recommendations are used to suggest a follow-up book that the members may want to read next, either as an extension of the same instant book club or as a newly constituted club. In select embodiments, recommendations are automatically generated based on previous purchases of members, book similarity (e.g., author, topic, characters, historical timeframe, geographic setting), known collaborative filtering techniques, libraries of other users (e.g., in their Google Books library listing), and analysis of content or metadata for matches to other books in system database 130.

In some instances, people who have already finished reading a book may nonetheless wish to join a book club. This may be of particular interest in cases where a book has a fairly small audience, so filtering potential members based on those acquiring the book at nearly the same time may not be feasible. It may also be the case for classics that may be well known but do not have the sales spike that new releases often enjoy. In this instance, a user updates information in the user profile data 310 to request a notification when a new book club is formed regarding a particular book.

Some book club members are traditionally active and have high visibility in the club, while others prefer to simply observe the activities of the club, and such preferences are easily fostered using system 100. In one embodiment, a user sets user profile data 310 such that social network 340 will recognize the user as only an observer of an instant book club's activities. In a specific embodiment, social network 340 provides an option allowing the club either to permit anonymous following of the club's activities or to require some level of identification such that the other members know who is “watching” their activities. In another embodiment, anonymous following is permitted but the members are told whenever such an anonymous follower signs up (even if the person's identity is not revealed).

In further embodiments, other available demographic information from user profile data 310 and social network 340 is used to help focus book club membership in an advantageous way. User age, for example, is one parameter that may be of great interest to users in determining which of several book clubs to join. Consider J. R. R. Tolkien's novel THE HOBBIT, which is frequently read both by middle school children on their own and by parents or grandparents to even younger children. The book clubs for each demographic likely would be extremely different; social network 340 thus supports demographic descriptions of clubs to allow appropriate selection by users.

Some users may find it preferable to be in a smaller book club in which they get to know all of the other members; others may prefer a larger club in which a wider variety of viewpoints is presented. Particularly for popular books with large numbers of users who would like to participate in an instant book club, social network 340 is configured to provide a user with options as to the user's preferable book club size. Book clubs of various sizes can then be established for any particular book.

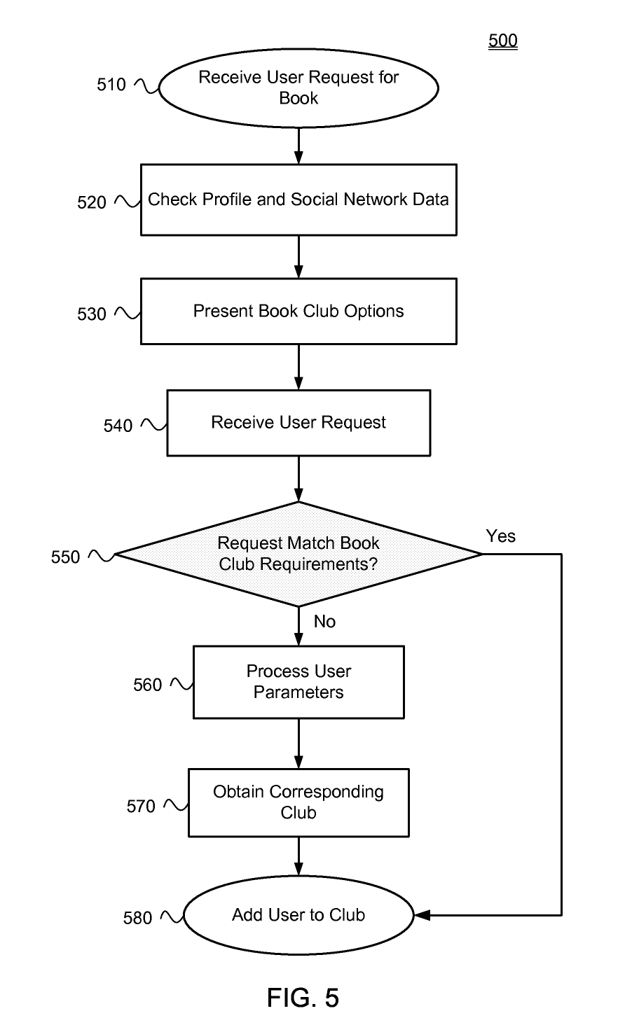

Referring now to FIG. 5, there is illustrated an exemplary method 500 of implementing an instant book club. Processing commences at step 510, in which a system (e.g., content hosting system 110) receives a request from a user for a book. In one embodiment, the user makes such a request via ordering subsystem 250 of reader module 181. For purposes of illustration here, discussion will focus on the instant book club creation steps, rather than other steps that may be taken in connection with the customer's request, such as provisioning the book data to reader module 181 and managing payment for the requested book.

In step 520, a check is made of the user's profile and social network data, for example as may be stored in user profile data 310 and social network 340 portions of system database 130. Relevant information such as the person's self-provided interest areas, age, and demographics, as well as automatically generated information such as the person's average time to read a book, are retrieved and used to determine which book clubs may best fit the user's interest.

In step 530, the book club options are presented to the user. In one embodiment, the user is presented with a list of all possible book clubs that the user might be interested in joining. In another embodiment, only those book clubs for which the user's profile presents a match above a threshold value are presented for the user to consider. For purposes of further discussion, consider the case in which all of the existing book clubs are presented in step 530 for the user to see.

Next, in step 540, the user's request is received, for instance a request to join a club of Boston-based readers who do not wish to have anonymous followers, who started the book about two weeks ago, and who read at a pace of approximately one chapter per week.

In step 550, a check is made to see whether the user's request is a good match for the requirements of the requested book club. If so, the user is immediately added to the club in step 580.

In some instances, however, there may be a mismatch between the request of the user and the rules applicable to the club. In this example, perhaps the club does not wish new members who are just starting the book, or perhaps the user has a history of reading books in their entirety within two days of purchasing access to them. Step 560 processes the corresponding parameters to generate a space characterizing the user. That information is then used in step 570 to obtain a corresponding club. In some instances, social network 340 may find an existing club that is a good match for the user and add the user to that club automatically in step 580 (providing the user opportunity to opt out, if desired). In other instances, the user's profile may not be a good match for any existing clubs, in which case social network 340 creates a new club with the user as the first member, then adds the user to that club in step 580 and (not shown) adds other members as promptly as practicable by recommending the new club to subsequent users with profiles that reasonably match those of the user. In this case, the user may need to wait a short period of time before there are other members, but the user will have a more satisfying experience because the club will be a good fit.

### Additional Considerations

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing electronic textbooks using a content hosting system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. An electronic book club hosting system comprising:
a system database storing book data and user profile information;
an ordering subsystem in communication with the system database, the ordering system being configured to provide a portion of the book data responsive to user selection of a book by a user; and
a social network subsystem in communication with the ordering subsystem, the social network subsystem configured to selectively and automatically enable user access to a book club responsive to the user profile information and responsive to the user selection of the book.

2. The electronic book club hosting system of claim 1, wherein the ordering subsystem is further configured to prompt the user to join the book club.

3. The electronic book club hosting system of claim 1, wherein the social network subsystem is further configured to select the book club based on at least one of user behavior, user geography, user date of order, user reading pace, user age, user affinities, previous purchases, desired book club size, and user interest.

4. The electronic book club hosting system of claim 1, wherein the social network subsystem is further configured to change a role in the book club to facilitate user interest in the book club.

5. The electronic book club hosting system of claim 1, wherein the social network subsystem is configured to select a student to fill a role in the book club.

6. The electronic book club hosting system of claim 1, wherein the social network subsystem is configured to select a teacher to fill a role in the book club.

7. The electronic book club hosting system of claim 1, wherein the ordering subsystem is further configured to provide a financial incentive for the user to participate in the book club.

8. The electronic book club hosting system of claim 1, wherein the portion of the book is a subset of chapters from the book.

9. The electronic book club hosting system of claim 1, wherein the social network subsystem is configured to allow a user to join the book club as an anonymous follower.

10. A computer-implemented method of providing a book club relating to a book, comprising:
receiving, at a processor, a user order for the book;
fulfilling the user order;
prompting the user to join the book club;
receiving a reply from the user; and
directing a social network processing facility to automatically connect the user with the book club responsive to the reply from the user.

11. The method of claim 10, further comprising selecting the book club responsive to at least one of user behavior, user geography, user date of order, user reading pace, user age, user affinities, previous purchases, desired book club size, and user interest.

12. The method of claim 10, further comprising automatically changing a role in the book club to facilitate user interest in the book club.

13. The method of claim 10, further comprising automatically selecting a student to fill a role in the book club.

14. The method of claim 10, further comprising automatically selecting a teacher to fill a role in the book club.

15. The method of claim 10, further comprising providing a financial incentive for the user to participate in the book club.

16. The method of claim 10, wherein fulfilling the user order comprises providing the user incremental access to the book in a manner consistent with the activities of the book club.

17. The method of claim 10, wherein directing the social network processing facility to connect the user with the book club includes permitting the user to join the book club as an anonymous follower.

18. The method of claim 10, further comprising operating the book club by automatically providing exchange of book annotations among members of the book club.

19. The method of claim 10, further comprising operating the book club by automatically providing exchange of references among members of the book club.

20. The method of claim 10, further comprising operating the book club by providing scheduling for activities by the book club.

21. The method of claim 10, further comprising presenting a plurality of potential book clubs to the user and permitting the user to select the book club from among the plurality of potential book clubs.

22. The method of claim 10, further comprising notifying the user when the book club is formed.

22. The method of claim 10, further comprising prompting a second user who previously obtained the book to join the book club.

24. A computer-implemented method of providing a book club relating to a book, comprising:
receiving, at a processor, a user order for the book;
prompting the user to join the book club; and
directing, responsive to a reply received from the user, portions of the book to be incrementally provided to the user responsive to a set of parameters for the book club.

25. The computer program product of claim 24, wherein the portions are delivered at a frequency corresponding to a desired reading pace for the book club.
